(19) United States
(12) Patent Application Publication
(10) Pub. No.: US 2022/0405161 A1
(43) Pub. Date: Dec. 22, 2022

(54) DATA SELECTION ASSIST DEVICE AND DATA SELECTION ASSIST METHOD

(71) Applicant: Hitachi, Ltd., Tokyo (JP)

(72) Inventor: Susumu SERITA, Tokyo (JP)

(73) Assignee: Hitachi, Ltd., Tokyo (JP)

(21) Appl. No.: 17/838,983

(22) Filed: Jun. 13, 2022

(30) Foreign Application Priority Data
Jun. 16, 2021 (JP) 2021-100050

(51) Int. Cl. G06F 11/07

(52) U.S. Cl. CPC G06F 11/079; G06F 11/0709

(57) ABSTRACT

A data selection device assists selection of suitable training data used for sign detection, and includes: a storage unit configured to store time-series sensor data acquired from a sensor with respect to a failure prediction target device; a data classification unit configured to classify the time-series sensor data into a first data set and a second data set while allowing the first data set and the second data set to overlap each other; a training data selection unit configured to select a subset of the second data set based on a value range of the first data set; a training data evaluation unit configured to calculate an evaluation index indicating a suitability of a failure prediction model as training data based on the selected subset; and a data selection condition search unit configured to search for the value range of the first data set that maximizes the evaluation index.

### CROSS-REFERENCE TO RELATED APPLICATION

This application claims priority pursuant to Japanese patent application No. 2021-100050, filed on Jun. 16, 2021, the entire disclosure of which is incorporated herein by reference.

### BACKGROUND

### Technical Field

The present invention relates to a data selection assist device and a data selection assist method.

### RELATED ART

If manufacture equipment, power generation equipment, and the like used at a production site cannot be used due to a failure, the manufacture equipment, the power generation equipment, and the like have a large influence such as a decrease in productivity of business. Therefore, it is required to detect a failure of a device at an early stage and prevent the failure in advance. An abnormality detection technique is one of methods for predicting a failure of a device.

In the abnormality detection technique, sensor data indicating a state of the device is collected from various sensors arranged in the device. Further, a mathematical model indicating a normal state of the device is trained based on the sensor data. In addition, the constructed model is applied to the sensor data acquired from the device, and a degree of abnormality thereof is calculated. When the degree of abnormality increases, the device determines that there is a high risk of the failure and outputs a warning or the like.

The construction of the mathematical model used for such abnormality detection mainly includes the following steps: 1) collecting data; 2) selecting a sensor to be used; 3) pre-processing; 4) extracting feature data; 5) training the model; and 6) validating the model.

In the “pre-processing”, a processing of data selection (also called data filtering) for selecting training data to be used for the model training is performed. This is because the collected sensor data may generally include data that is inappropriate for training.

For example, immediately after the device is started, an operation is not stable and the sensor data fluctuates greatly. The model training based on such sensor data can lead to overlooking of a failure sign and erroneous detection. Therefore, it is necessary to remove inappropriate data by selecting the data in the “pre-processing”.

For example, as the related art regarding selection of training data or the like, a training data confirmation assist device (see JP-A-2020-102001) or the like that facilitates confirmation of whether inappropriate data is mixed when training data to be used at a time of machine learning is acquired is proposed.

The training data confirmation assist device performs abnormality detection of an industrial machine using the machine learning, and thus facilitates the confirmation of mixing of the inappropriate data when the training data including only normal data is acquired in advance. The training data confirmation assist device includes a data acquisition unit that acquires measurement data including time series data indicating at least one of predetermined state data and control data related to control when the industrial machine performs a certain operation, and a display control unit that displays a graph by superimposing the same type of data on each other in a state in which a plurality of pieces of the time series data acquired by the data acquisition unit are aligned in a direction of a time axis.

In the above related art, it is necessary for an operator to make a determination by looking at the graph. Therefore, the determination of whether the data is inappropriate may be a personal action. In addition, when it is necessary to confirm large-scale measurement data or when a change pattern of the measurement data is complicated, the determination cannot be handled manually and the handling itself becomes difficult.

### SUMMARY

An object of the invention is to provide a technique capable of assisting selection of suitable training data to be used for sign detection even when the sign detection of a device is performed based on large-scale measurement data or measurement data having a complicated change pattern.

A data selection assist device of the invention that solves the above problem includes: a storage unit configured to store time-series sensor data acquired from a sensor with respect to a failure prediction target device; a data classification unit configured to classify the time-series sensor data into a first data set and a second data set while allowing the first data set and the second data set to overlap each other, based on a predetermined condition according to a type of the sensor; a training data selection unit configured to select a subset of the second data set based on a value range of the first data set; a training data evaluation unit configured to calculate an evaluation index indicating a suitability of a failure prediction model as training data based on the selected subset; and a data selection condition search unit configured to search for the value range of the first data set that maximizes the evaluation index.

In addition, a data selection assist method of the invention includes: by an information processing device, storing time-series sensor data acquired from a sensor with respect to a failure prediction target device; classifying the time-series sensor data into a first data set and a second data set while allowing the first data set and the second data set to overlap each other, based on a predetermined condition according to a type of the sensor; selecting a subset of the second data set based on a value range of the first data set; calculating an evaluation index indicating a suitability of a failure prediction model as training data based on the selected subset; and searching for the value range of the first data set that maximizes the evaluation index.

According to the invention, it is possible to assist the selection of suitable training data to be used for sign detection even when the sign detection of a device is performed based on large-scale measurement data or measurement data having a complicated change pattern.

### BRIEF DESCRIPTION OF THE DRAWINGS

FIG. 1 is a diagram showing an overall configuration example of a sign detection system according to a first embodiment.

FIG. 2 is a diagram showing a configuration example of a data selection assist device according to the first embodiment.

FIG. 3 is a diagram showing a configuration example of sensor data according to the first embodiment.

FIG. 4 is a diagram showing a configuration example of a failure history according to the first embodiment.

FIG. 5A is a diagram showing a sensor classification example of an optimization setting value according to the first embodiment.

FIG. 5B is a diagram showing an example of a fixed selection condition of the optimization setting value according to the first embodiment.

FIG. 5C is a diagram showing an example of a selection condition to be searched of the optimization setting value according to the first embodiment.

FIG. 5D is a diagram showing an example of a search parameter of the optimization setting value according to the first embodiment.

FIG. 6 is a diagram showing a processing flow in a data selection optimization unit according to the first embodiment.

FIG. 7 is a diagram showing a flow example in a data selection condition search unit according to the first embodiment.

FIG. 8 is a diagram showing a processing concept in a training data selection unit according to the first embodiment.

FIG. 9A is a diagram showing an example of data distribution of a model sensor according to the first embodiment.

FIG. 9B is a diagram showing an example of data distribution of the model sensor according to the first embodiment.

FIG. 10A is a diagram showing an example of a target device in an optimization setting value according to a second embodiment.

FIG. 10B is a diagram showing an example of a data period in the optimization setting value according to the second embodiment.

FIG. 11 is a diagram showing a flow example in a training data evaluation unit according to the second embodiment.

FIG. 12 is a diagram showing a conceptual example of period labeling according to the second embodiment.

FIG. 13A is a diagram showing a conceptual example of a degree of abnormality and a threshold value according to the second embodiment.

FIG. 13B is a diagram showing a conceptual example of a period for verification data and a labeling period according to the second embodiment.

### DETAILED DESCRIPTION OF EMBODIMENTS

Hereinafter, a first embodiment and a second embodiment of the invention will be described with reference to the drawings. A difference between the first embodiment and the second embodiment is a characteristic of sensor data used when acquiring an optimum data selection condition and an evaluation index that evaluates training data.

According to the first embodiment, the optimum data selection condition is output using the sensor data acquired from a target device for which a failure prediction model is to be constructed. In addition, a computable evaluation index is used even if the target device has not experienced a failure in the past.

On the other hand, according to the second embodiment, the optimum data selection condition is output using sensor data acquired from a device other than the target device for which the failure prediction model is to be constructed. The target device includes a device that has experienced a failure in the past. In addition, an index based on an accuracy of the failure prediction model is used as the evaluation index of the training data.

### First Embodiment

### System Configuration

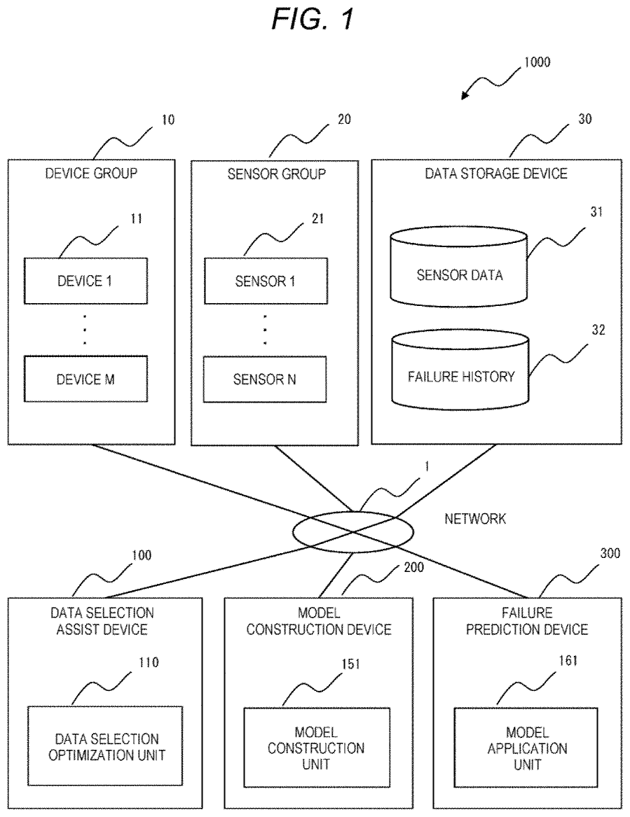

Hereinafter, embodiments of the invention will be described in detail with reference to the drawings. FIG. 1 is a diagram showing an overall configuration example of a sign detection system 1000 according to the present embodiment. The sign detection system 1000 shown in FIG. 1 includes a data selection assist device 100, and can assist selection of suitable training data to be used for sign detection even when the sign detection of a device is performed based on large-scale measurement data or measurement data having a complicated change pattern.

As illustrated in FIG. 1, the sign detection system 1000 according to the present embodiment includes a device group 10, a sensor group 20, a data storage device 30, the data selection assist device 100, a model construction device 200, and a failure prediction device 300 that are connected to each other via a network 1 so as to be able to communicate data with each other. The data selection assist device 100 may include at least one of functions of the model construction device 200 and the failure prediction device 300. In addition, the data storage device 30 may be a storage device of the data selection assist device 100. That is, each information processing device included in the sign detection system 1000 may be implemented by a separate server or the like, or may be implemented by one server or the like.

The device group 10 includes a plurality of devices 11 that are failure prediction targets. When one device 11 includes a plurality of portions (parts or components), each component may be regarded as the device 11.

The sensor group 20 includes a plurality of sensors. Each sensor 21 measures physical data such as acceleration and temperature of the above device 11. Generally, one device 11 is provided with a plurality of the sensors 21.

In addition, the data storage device 30 stores sensor data 31 and a failure history 32. The sensor data 31 is a database that stores data in which the target devices 11, values measured by the sensors 21, and measurement times are recorded.

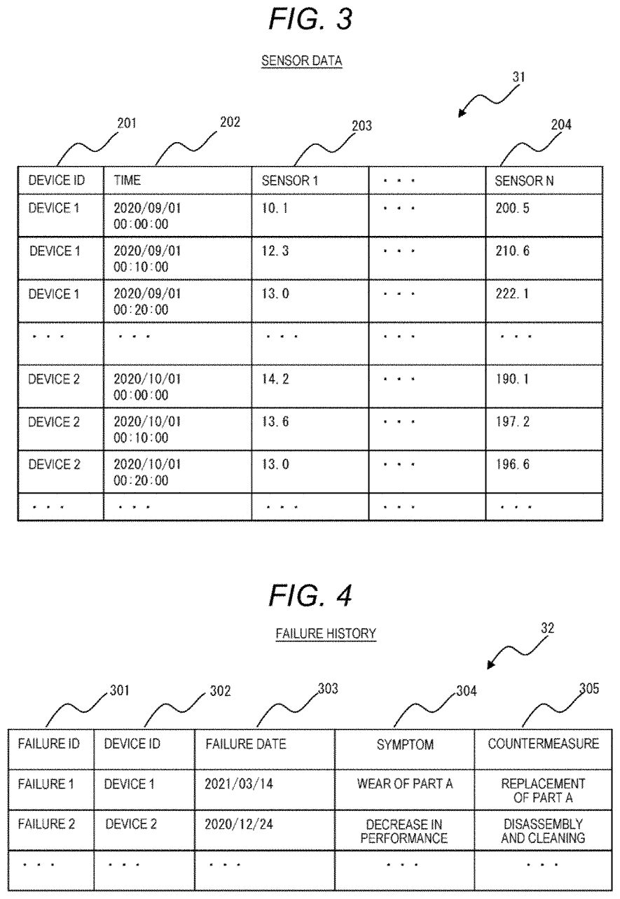

The sensor data 31 includes both data over a certain period in the past (offline data) and data acquired in real time (online data). The details of such sensor data 31 will be described with reference to FIG. 3.

On the other hand, the failure history 32 is a database that stores information on failures, such as the devices 11 in which a failure occurred, failure dates, and failure symptoms. The details of such a failure history 32 will be described with reference to FIG. 4.

The data selection assist device 100 includes at least a data selection optimization unit 110. The data selection optimization unit 110 searches for training data selection conditions used for constructing the failure prediction model using the sensor data 31 and the failure history 32, and generates an optimum data selection condition.

The model construction device 200 includes a model construction unit 151. The model construction unit 151 selects the data of the sensor data 31 using the optimum training data selection condition generated by the data selection optimization unit 110, and trains the failure prediction model using the sensor data after the data selection.

A specific processing flow is as follows. First, the model construction unit 151 inputs the past sensor data 31 of the target device (device 11) for which the failure prediction model is to be constructed. The amount of the sensor data 31 to be input may vary depending on available data. For example, the sensor data 31 for the past three months may be used.

The model construction unit 151 selects data to be used for the training data and data not to be used for the training data based on the optimum data selection condition generated by the data selection optimization unit 110. The model construction unit 151 trains the failure prediction model using the selected training data. The failure prediction model is trained by a learning algorithm selected in advance.

The learning algorithm may be any method as long as it is a method for constructing a normal model using the given sensor data. For example, a Mahalanobis Taguchi (MT) method, One class SVM, and the like can be used.

The model construction unit 151 trains the failure prediction model by the above model training. The trained failure prediction model is stored in the failure prediction device 300 so that a model application unit 161 can use the model. A feature of the invention is to optimize the data selection condition to be used for model construction, and the failure prediction model may be trained by using an existing method such as machine learning.

The failure prediction device 300 includes the model application unit 161. The model application unit 161 applies the failure prediction model constructed by the model construction unit 151 to the sensor data 31 acquired from the device 11 to be detected in real time, and calculates the degree of abnormality. In addition, the model application unit 161 outputs a warning or the like when the degree of abnormality exceeds a preset threshold value.

A specific processing flow is as follows. First, the model application unit 161 acquires the sensor data 31 from the sensor 21 of the failure prediction target device 11.

The model application unit 161 applies the optimum training data selection condition generated by the data selection optimization unit 110 to the sensor data 31. When detection target online sensor data at a certain time satisfies the optimum data selection condition, the model application unit 161 applies the failure prediction model constructed by the model construction unit 151 to the sensor data. If the optimum data selection condition is not satisfied, the model is not applied.

The model application unit 161 calculates the degree of abnormality depending on whether the detection target online sensor data satisfies the training data selection condition. If the training data selection condition is satisfied, the model application unit 161 applies the model to the detection target online sensor data and calculates the degree of abnormality.

A method for calculating the degree of abnormality differs depending on the learning algorithm to be used. For example, when the MT method is used, a Mahalanobis distance between the normal data defined by detection target offline sensor data after the data selection application is applied and the detection target online sensor data is used as the degree of abnormality. On the other hand, if the training data selection condition is not satisfied, the degree of abnormality is not calculated by the model, and a preset value (for example, 0) is output as the degree of abnormality. Similar to the model construction, the existing method such as the machine learning can be used to apply the model.

### Hardware Configuration

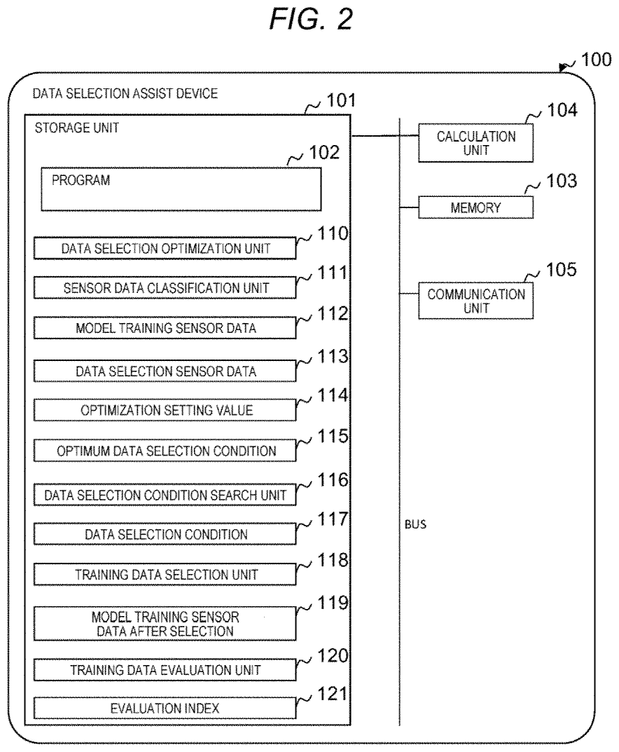

In addition, a hardware configuration of the data selection assist device 100 according to the present embodiment is as shown in FIG. 2. That is, the data selection assist device 100 includes a storage unit 101, a memory 103, a calculation unit 104, and a communication unit 105.

The storage unit 101 is implemented by appropriate non-volatile storage elements such as a solid state drive (SSD) or a hard disk drive.

The memory 103 is implemented by a volatile storage element such as a RAM.

The calculation unit 104 is a CPU that executes a program 102 stored in the storage unit 101 by reading the program 102 into the memory 103 or the like, performs integrated control of the device itself, and performs various determinations, calculations, and control processings.

The communication unit 105 assumes a network interface card or the like that is connected to the network 1 and is responsible for communication processing with the data storage device 30, the model construction device 200, the failure prediction device 300, and the like.

When the data selection assist device 100 is a stand-alone machine, it is preferable that the data selection assist device 100 further includes an input device that accepts key input and voice input from a user, and an output device such as a display that displays processing data.

At least various data is stored in the storage unit 101 in addition to the program 102 for implementing a function necessary for the data selection assist device 100 according to the present embodiment. Functional units such as the data selection optimization unit 110, a sensor data classification unit 111, a data selection condition search unit 116, a training data selection unit 118, and a training data evaluation unit 120 are implemented by executing the program 102 by the calculation unit 104. Surely, the functional units may be implemented by appropriate hardware such as an electronic circuit.

### Data Structure Example

Subsequently, various data used by the data selection assist device 100 according to the present embodiment will be described. FIG. 3 shows an example of the sensor data 31 according to the present embodiment.

The sensor data 31 stores a device ID for identifying the device 11 to which the sensor 21 is arranged, a time at which a sensor value is measured, and a value measured by each sensor 21 at the time.

In the example in FIG. 3, a total of N sensor values from a “sensor 1” to a “sensor N” are measured at each time. Such sensor values may be numerical data that quantifies a state of the device such as acceleration, or category data that qualitatively expresses a state of the device such as an operation mode.

Subsequently, FIG. 4 shows a configuration example of the failure history 32. The failure history 32 according to the present embodiment includes values of a device ID, the failure date, the failure symptom, a countermeasure, and the like, using a failure ID as a key.

The failure ID is an identifier that uniquely specifies a failure case. In addition, the device ID is an identifier that identifies a device in which a failure occurred. In addition, the failure date indicates a date on which the failure occurred. The symptom indicates a symptom and a cause of the failure. The countermeasure represents a measure taken for the failure such as replacement of a component.

The information included in the failure history 32 may be acquired from a maintenance system or the like operated by a management company or the like of the device 11. Alternatively, the information may be acquired from a file such as a maintenance ledger managed by a person in charge of maintenance work or the like.

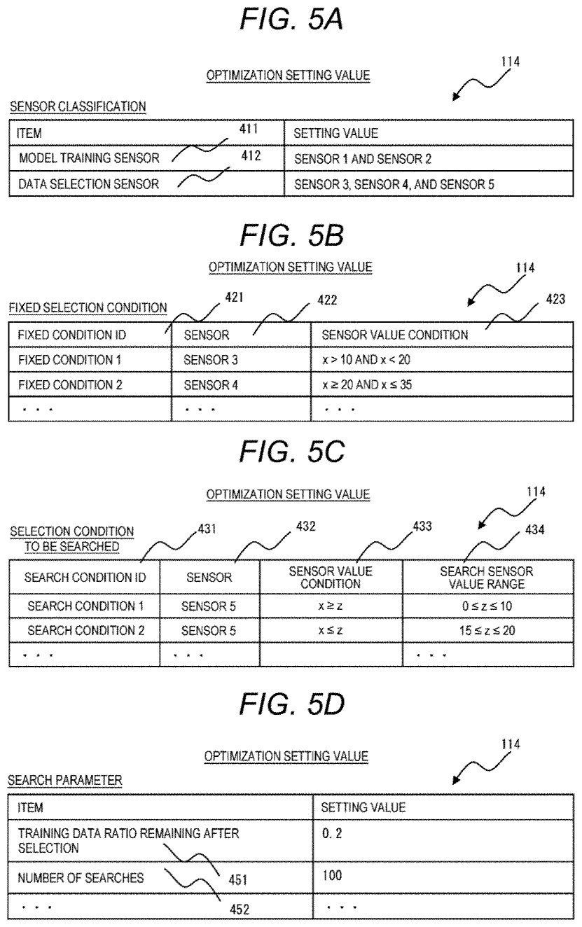

Subsequently, FIGS. 5A to 5D show examples of an optimization setting value 114 used when the data selection optimization unit 110 generates the optimum data selection condition. The optimization setting value 114 includes “sensor classification” shown in FIG. 5A, a “fixed selection condition” shown in FIG. 5B, a “selection condition to be searched” shown in FIG. 5C, a “search parameter” shown in FIG. 5D, and the like.

The sensor classification shown in FIG. 5A includes items 411 and 412 of a model training sensor and a data selection sensor. The model training sensor 411 specifies a set of sensors used for training the failure prediction model among the available sensors 21.

The model construction unit 151 trains the failure prediction model by the learning algorithm specified in advance by using the sensor data acquired from the specified sensors 21 as the training data.

The data selection sensor 412 specifies a set of sensors used for generating the data selection condition among the available sensors 21. The model construction unit 151 selects the training data using the data selection condition including the specified sensors. Each column of the model training sensor 411 and the data selection sensor 412 includes at least one sensor as a setting value. In addition, each column of the model training sensor 411 and the data selection sensor 412 may include overlapping sensors as setting values.

The data selection optimization unit 110 combines two types of data selection conditions and outputs a final data selection condition. One is the “fixed selection condition” in which the sensor 21 used for data selection and a value range of the sensor 21 are defined in advance. The other is the “selection condition to be searched” in which only the sensor 21 used for the data selection is defined and the value range of the sensor 21 is determined through the search. All the sensors specified by the fixed selection condition and the selection condition to be searched are registered as the data selection sensors.

FIG. 5B is a diagram showing an example of the fixed selection condition. The fixed selection condition stores values of a fixed condition ID 421, a sensor 422, and a sensor value condition 423. The fixed condition ID 421 is an identifier that uniquely specifies the fixed selection condition.

The sensor 422 indicates the sensor 21 used for the fixed selection condition. The sensor value condition 423 represents a conditional expression for the sensor value of the selected sensor 21. For example, a condition shown by a “fixed condition 1” in FIG. 5B indicates that a value of a “sensor 3” is limited to “a range larger than 10 and smaller than 20”. Here, a variable x represents the value of the “sensor 3”. The sensor value condition 423 may be any expression as long as it is an expression that limits the value range with respect to the sensor value.

FIG. 5C is a diagram showing an example of the “selection condition to be searched”. The “selection condition to be searched” stores values of a search condition ID 431, a sensor 432, a sensor value condition 433, and a search sensor value range 434.

The search condition ID 431 is an identifier that uniquely specifies the selection condition to be searched.

The sensor 432 represents the sensor 21 used for the selection condition to be searched. In addition, the sensor value condition 433 represents a conditional expression for the sensor value of the selected sensor 21. A difference from the sensor value condition of the fixed selection condition is a condition based on the variable x that represents the sensor value and a variable z to be searched. Various values of the variable z are assigned in a process of searching for the optimum data selection condition by the data selection optimization unit 110.

The search sensor value range 434 represents a range of the variable z that can be taken. The data selection optimization unit 110 assigns various values to the variable z within the defined range. In the example in the figure, a “search condition 1” represents that a sensor value of a “sensor 5” is searched in a range of 0≤z≤10. Further, a result of the search by the data selection optimization unit 110 represents that a sensor value condition of x≥z (x≥5) is derived for the selected sensor value z (for example, 5).

FIG. 5D is a diagram showing an example of the “search parameter”. The “search parameter” stores values of a training data ratio 451 remaining after selection and the number of searches 452. The training data ratio 451 remaining after the selection defines the number of data to be satisfied by the optimum data selection condition generated by the data selection optimization unit 110.

When the data selection is applied to the training sensor data, the number of records of training data is reduced as compared with that before the data selection. If the number of training data is too small, a reliable failure prediction model cannot be trained. Therefore, the data selection optimization unit 110 applies a limitation so that the training data after the data selection remains at a certain ratio or more. In the example in the figure, at least 0.2 (20%) of the training data means a limit remaining after the data selection. Instead of specifying the limit in a form of a ratio, the number of records (for example, 1000 records) of the training data that should remain after the data selection may be specified.

The number of searches 452 represents the number of searches for the data selection condition by the data selection optimization unit 110 according to the selection condition to be searched.

### Functional Unit: Data Selection Optimization Unit

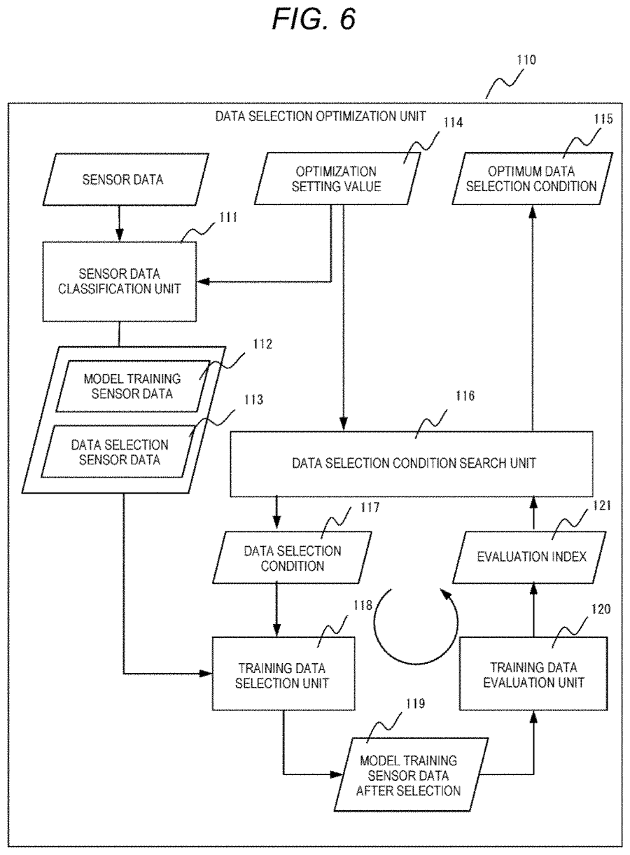

Subsequently, FIG. 6 shows a processing flow of the data selection optimization unit 110. The data selection optimization unit 110 includes the functional units such as the sensor data classification unit 111, the data selection condition search unit 116, the training data selection unit 118, and the training data evaluation unit 120.

The sensor data classification unit 111 classifies the input sensor data 31 into model training sensor data and data selection sensor data. The classification is performed with reference to the setting of the sensor classification (FIG. 5A).

The sensor data belonging to the model training sensor is classified into the model training sensor data, and the sensor data belonging to the data selection sensor is classified into the data selection sensor data. The sensor data classification unit 111 stores the classified model training sensor data and data selection sensor data in an internal memory.

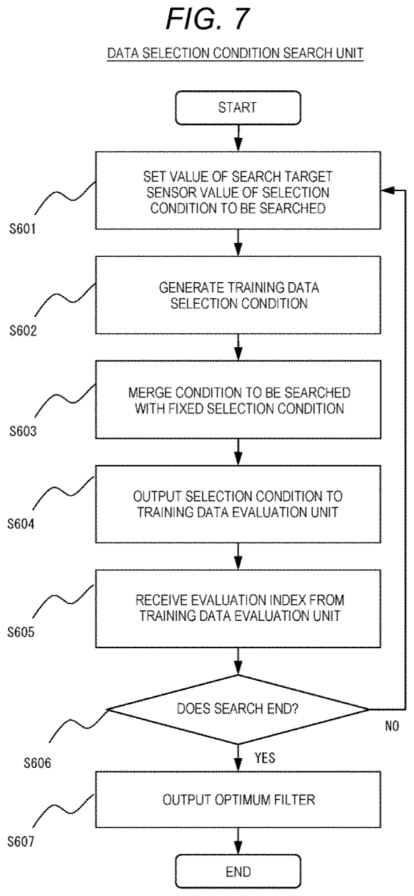

The data selection condition search unit 116 generates a plurality of the data selection conditions in order to obtain the optimum data selection condition. Among the plurality of data selection conditions, the data selection condition that maximizes an evaluation index 121 is output as an optimum data selection condition 117. A specific processing of the data selection condition search unit 116 will be described with reference to a flow in FIG. 7.

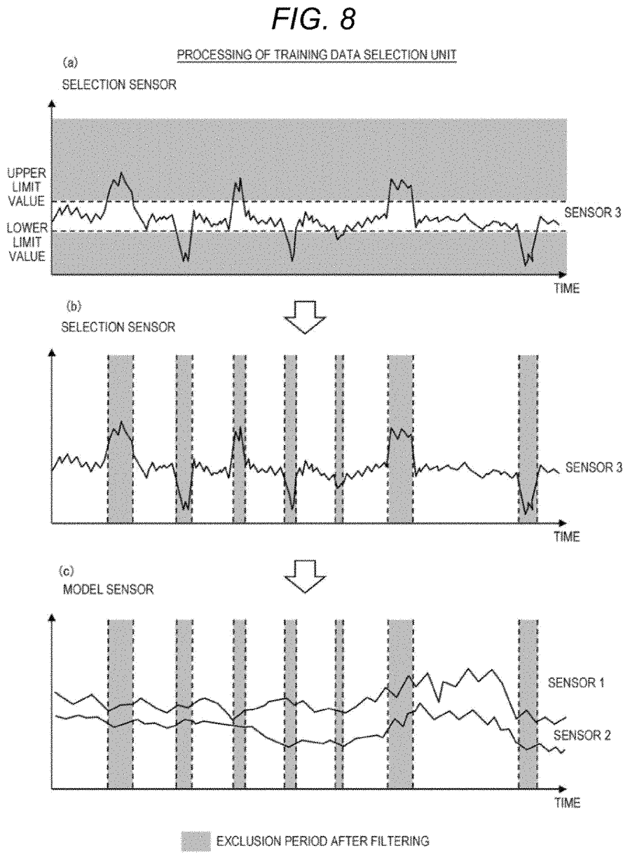

The training data selection unit 118 applies the data selection condition 117 output by the data selection condition search unit 116 to the data selection sensor data and the model training sensor data to select data for the model training sensor data. A specific processing flow of the data selection will be described with reference to FIG. 8. The training data selection unit 118 transmits model training sensor data 119 after the data selection to the training data evaluation unit 120.

The training data evaluation unit 120 calculates the evaluation index 121 that evaluates whether the sensor data is appropriate as the training data by using the model training sensor data 119 after the data selection.

For example, the following indexes can be used as the evaluation index 121. One is an index for measuring a degree of similarity with normal distribution. In general, based on an assumption that the sensor data has the normal distribution when the device is operating normally, an index that takes a higher value as the sensor data after the data selection is closer to the normal distribution can be used as the evaluation index. For example, an index such as skewness or kurtosis may be used.

Alternatively, an average value of the degrees of abnormality with respect to the training data may be used. The model is trained using the sensor data after the data selection. The obtained model is applied to the training data and the degrees of abnormality are calculated. Further, the average value of the degrees of abnormality with respect to the training data is calculated. Normally, since it is preferable that the degrees of abnormality with respect to the training data are small, a value obtained by reversing positive and negative signs of the average value is used as an evaluation index of final training data. The training data evaluation unit 120 transmits the calculated evaluation index 121 to the data selection condition search unit 116.

The data selection optimization unit 110 obtains an optimum data selection condition 115 by repeating a cycle of generation and evaluation of the data selection condition multiple times.

### Flow Example

Hereinafter, an actual procedure of a data selection assist method according to the present embodiment will be described with reference to the drawings. Various operations corresponding to the data selection assist method to be described later are implemented by a program executed by the data selection assist device 100 by reading the program into a memory or the like. The program includes codes for performing various operations to be described later.

FIG. 7 is a diagram showing a flow example of the data selection assist method according to the present embodiment, and in particular, shows a flow of the data selection condition search unit 116. The data selection optimization unit 110 starts this flow at a timing of receiving an instruction from the user, for example, via an appropriate user terminal or a UI installed in the user terminal.

(step 3601) First, the data selection condition search unit 116 sets a value of a search target sensor value of the “selection condition to be searched”. In this case, the data selection condition search unit 116 reads the search condition of the “selection condition to be searched” specified by the optimization setting value 114 (FIG. 5C). Further, the value z of the target sensor is set for each search condition based on the search sensor value range 434.

For example, when the search condition includes the “search condition 1” and a “search condition 2′”, a value corresponding to a lower limit value of the “sensor 5” is set to 5 (search condition 1), and a value corresponding to an upper limit value of the “sensor 5” is set to 17 (search condition 2). The data selection condition search unit 116 sets values of search sensor values included in all the search conditions.

When this step is executed for a first time, the values of the search sensor values are optionally set within a range of the search sensor value. On the other hand, when this step is executed for a second time or later, a next setting value is determined based on a combination of the search sensor values tried so far and the evaluation index 121 calculated by the training data evaluation unit 120. A method for selecting the next setting value depends on a parameter search algorithm to be used.

Here, the parameter search algorithm refers to an algorithm that searches for a set of variables that maximize a predefined objective variable from a set of variables according to a certain constraint condition. For example, Bayesian optimization or a genetic algorithm may be used.

(step S602) Next, the data selection condition search unit 116 generates the training data selection condition based on the search target sensor value set in step S601 described above. In this case, the data selection condition search unit 116 replaces the variable z of the sensor value condition with the search target sensor value set in S601. Accordingly, the sensor value condition regarding the specified sensor (“sensor 5” in FIG. 5C) is obtained. The processing is applied to all search conditions.

(step S603) Next, the data selection condition search unit 116 merges the training data selection condition obtained in step S602 described above with a set of “fixed selection conditions” (FIG. 5B) to generate the data selection condition.

(step S604) Next, the data selection condition search unit 116 outputs the data selection condition generated in step S603 described above to the training data evaluation unit 120. After this output, the data selection condition search unit 116 waits until an input is received from the training data evaluation unit 120.

(step S605) Next, the data selection condition search unit 116 receives the evaluation index 121 from the training data evaluation unit 120. The data selection condition search unit 116 stores a set of the search sensor value to be used for the data selection condition and the calculated evaluation index 121 in the internal memory.

(step S606) Next, the data selection condition search unit 116 determines whether the search sensor value was searched. A determination method depends on the parameter search algorithm to be used. For example, it may be determined whether the preset number of searches was reached.

When it is determined that the search is completed (S606: YES), the data selection condition search unit 116 advances the processing to step S607. When the search is not completed (S606: NO), the data selection condition search unit 116 returns to step S601 and repeats the processing.

(step S607) When the search is completed, the data selection condition search unit 116 outputs the optimum data selection condition 115. As the optimum data selection condition 115, the search sensor value having the maximum evaluation index 121 is selected from among the search sensor values tried so far. If there are search sensor values having the same data selection performance index, one of them is output.

After the optimum data selection condition 115 is output, the data selection condition search unit 116 ends this flow.

### Processing of Training Data Selection Unit

Subsequently, FIG. 8 shows a conceptual example in which the training data selection unit 118 actually selects the training data. In the example in FIG. 8, it is assumed that the training data is selected for the sensor data of the “sensor 3”.

For example, when the selection condition of the training data is expressed as “x>10 AND x<20”, the training data selection unit 118 extracts a region in which the sensor value of the “sensor 3” of the sensor data 31 satisfies this condition, that is, a range between a lower limit value “10” and an upper limit value “20” ((a) of FIG. 8).

Next, the training data selection unit 118 extracts a period having a value in the value range extracted as described above ((b) of FIG. 8). Then, the training data selection unit 118 extracts the same period as the above extracted period from the sensor data of a model sensor and uses the period for the model training ((c) of FIG. 8).

By this series of processing, the training data selection unit 118 obtains the period of the model sensor from the sensor value condition. If there are a plurality of the sensor value conditions, the same processing is repeated to obtain a final period.

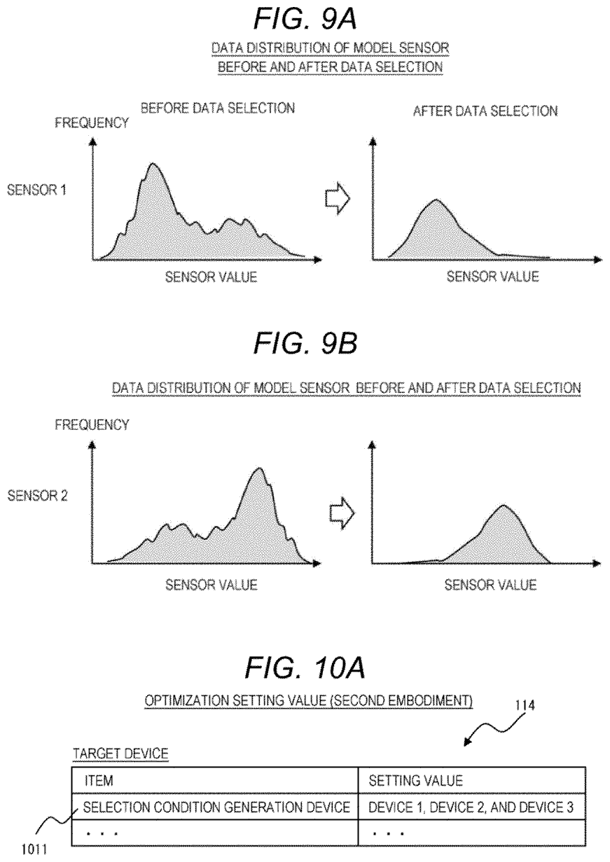

FIGS. 9A and 9B are diagrams showing a change in distribution of the model sensor data before and after the training data selection unit 118 applies the data selection to the model sensor data. Generally, when the data selection is applied to the sensor data by the series of processings described with reference to FIG. 8, a part of the data before the data selection is excluded and the data distribution changes. FIGS. 9A and 9B are diagrams in which frequency graphs indicating the data distribution of the “sensor 1” and the “sensor 2”, which are the model sensors, are compared before and after the data selection.

### Second Embodiment

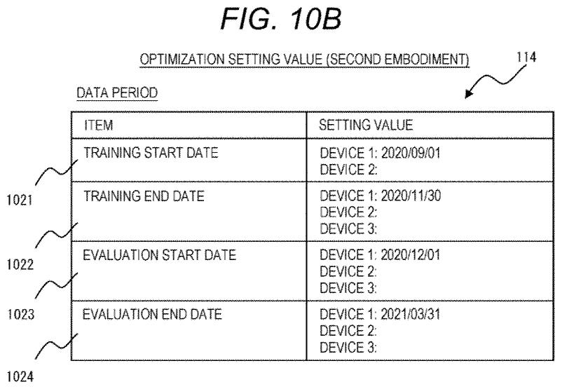

Subsequently, a second embodiment will be described below with reference to FIGS. 10 to 13. FIG. 10 is a diagram showing an example of a setting value newly added to the optimization setting value 114 described with reference to FIGS. 5A to 5D. The optimization setting value 114 added here relates to a target device and a data period.

FIG. 10A is a diagram showing a setting example of the target device in the optimization setting value 114 according to the second embodiment. Setting information of the target device stores the setting value of a selection condition generation device 1011 or the like. The selection condition generation device is a set of devices used by the data selection optimization unit 110 to generate the optimum data selection condition 115.

The data selection optimization unit 110 outputs one optimum data selection condition 115 by using the sensor data 31 and the failure history 32 that are acquired from the defined set of devices. In the example in FIG. 10A, data acquired from three devices of “device 1”, “device 2”, and “device 3” set as the “selection condition generation device” is used.

As long as one or more devices are defined as the “selection condition generation device”, any number of devices may be defined as the “selection condition generation device”. In addition, the “selection condition generation device” may be defined by, for example, a set of devices having the same product type.

FIG. 10B is a diagram showing a setting example of a data period in the optimization setting value 114 according to the second embodiment. Setting information of the data period stores setting values of a training start date 1021, a training end date 1022, an evaluation start date 1023, and an evaluation end date 1024.

The setting value of the training start date 1021 represents a start date of sensor data used for training a failure prediction model (earliest measurement date among the sensor data to be used) for each device defined in a “selection condition generation device” column. Similarly, the training end date represents an end date of the sensor data used for training the failure prediction model (latest measurement date among the sensor data to be used).

The data selection optimization unit 110 selects training data based on the values of the training start date 1021 and the training end date 1022 defined here, and performs data selection optimization. In addition, the setting value of the evaluation start date 1023 represents a start date of the sensor data used for evaluating the failure prediction model (earliest measurement date among the sensor data to be used) for each device defined in the “selection condition generation device” column. Similarly, the evaluation end date represents an end date of the sensor data used for evaluating the failure prediction model (latest measurement date among the sensor data to be used).

### Flow: Training Data Evaluation Unit

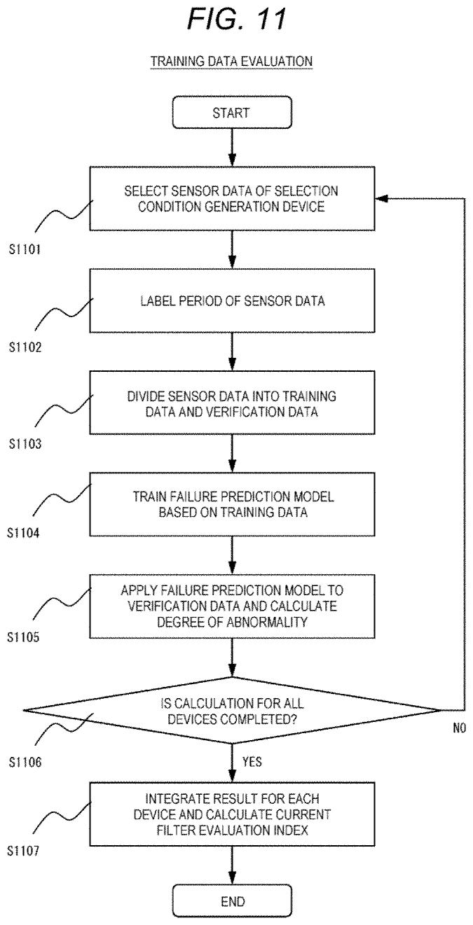

FIG. 11 is a diagram showing a processing example in the training data evaluation unit 120 according to the second embodiment. The training data evaluation unit 120 starts this flow, for example, at a timing of receiving an instruction from a user via an appropriate user terminal or UI.

(step S1101) First, the training data evaluation unit 120 reads the information of the target devices specified by the setting values of the selection condition generation device 1011 of the optimization setting value 114. Then, the training data evaluation unit 120 selects one of the target devices. If this step is executed for a first time, the training data evaluation unit 120 selects any target device. If this step is executed from a second time or later, the training data evaluation unit 120 selects the target device from the target devices that were not selected yet.

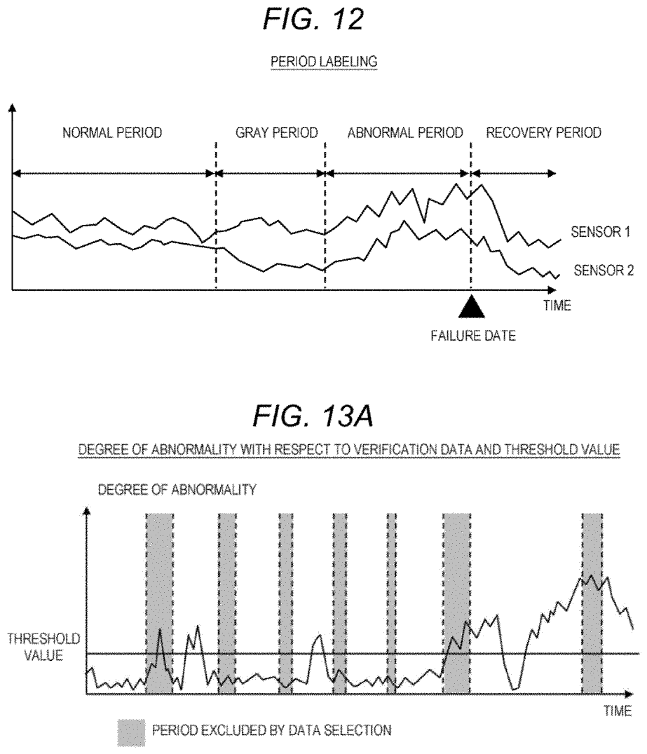

(step S1102) Next, the training data evaluation unit 120 labels the sensor data 31. The labeling is a processing of classifying each time of the sensor data 31 into any of a normal period, a gray period, an abnormal period, and a recovery period. The details of the period labeling will be described with reference to FIG. 12.

(step S1103) Next, the training data evaluation unit 120 refers to period-labeled sensor data obtained by the labeling described above, and selects the training data to be used for training the failure prediction model. As the training data, the sensor data during the normal period classified by period labeling is selected.

For example, a period of a preset training window width (for example, 3 months) from a start date of the normal period is selected as the training data.

Further, the training data evaluation unit 120 divides the sensor data 31 of the device selected in S1101 into training data and verification data based on the selected training data. The verification data refers to data after the training data (observation time) that is not included in the training data among the sensor data 31. The training data evaluation unit 120 stores the divided training data and verification data in the internal memory.

(step S1104) Next, the training data evaluation unit 120 trains the failure prediction model for the device selected in step S1101. The data used for training is the data related to the device selected in step S1101 among the data selected by the training data selection unit 118, and is the training data divided and generated in step S1103. A processing of training the failure prediction model is the same as the processing performed by the model construction unit 151.

(step S1105) Next, the training data evaluation unit 120 applies the failure prediction model generated in step S1104 to the verification data divided and generated in step S1103. A processing of model application is the same as the processing of the model application unit 161. However, the verification data is input instead of the online data.

The training data evaluation unit 120 applies the failure prediction model to the verification data and calculates a degree of abnormality. The calculated degree of abnormality is stored in the internal memory.

(step S1106) Next, the training data evaluation unit 120 confirms whether the above calculation of the degree of abnormality was completed for all the devices included in the “selection condition generation device”. If the calculation is completed (S1106: YES), the training data evaluation unit 120 proceeds to step S1107. If the calculation is not completed (S1106: NO), the training data evaluation unit 120 returns to step S1101 and repeats the processing.

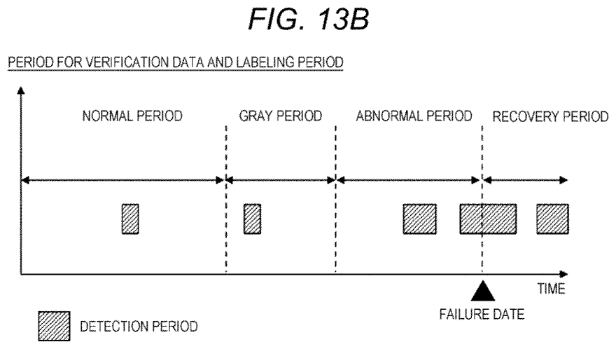

(step S1107) After the calculation of the degree of abnormality for all the target devices is completed, the training data evaluation unit 120 integrates the degree of abnormality for each device and calculates the evaluation index 121. The details of a method for calculating the evaluation index 121 will be described with reference to FIG. 13. The training data evaluation unit 120 outputs the calculated evaluation index 121 to the data selection condition search unit 116, and ends the processing.

### Period Labeling

FIG. 12 is a diagram showing a state of a period labeling processing in a data selection optimization processing performed by the training data evaluation unit 120.

The training data evaluation unit 120 labels the input sensor data 31. The labeling is the processing of classifying each time of the sensor data into any of the normal period, the gray period, the abnormal period, and the recovery period.

The normal period refers to a period during which it is guaranteed that the target device is operating normally. The model construction unit 151 trains a normal model by using the data of the normal period. The abnormal period refers to a period during which it is guaranteed that the target device behaves abnormally.

The gray period is located between the normal period and the abnormal period, and refers to a period during which it is difficult to determine normality and abnormality. Except for a sudden failure, in general, the device continuously transitions from a normal state to an abnormal state. Therefore, a period that cannot be clearly determined as the normal period or the abnormal period is defined as the gray period.

The recovery period refers to a period during which the device fails, is repaired and returns to the normal state. Although the device is in the normal state, the device may behave differently from the normal state before the failure due to the repair or the like, and thus the recovery period is defined separately from the normal period.

The example in the figure is an example of the period labeling for a device that failed in the past. A device that did not fail has no abnormal period, only the normal period or the gray period.

The period labeling may be performed for each device based on information on which maintenance or the like was performed, or may be determined by a rule based on domain knowledge. When the period labeling is determined by the rule, for example, the period labeling may be performed by a rule that three months before the failure date are defined as the abnormal period, two months before the abnormal period are defined as the gray period, and the remaining period is defined as the normal period.

### Degree of Abnormality

FIGS. 13A and 13B are diagrams showing the evaluation index 121 calculated by the training data evaluation unit 120. In step S1107, the training data evaluation unit 120 calculates the degree of abnormality for the verification data related to the “selection condition generation device”. FIG. 13A shows the degree of abnormality with respect to the verification data of one device.

The training data evaluation unit 120 extracts a detection period from the degree of abnormality based on a preset threshold value. The detection period is a period during which the degree of abnormality exceeds the threshold value. This threshold value is set based on a detection algorithm and the training data to be used. For example, a threshold value 4 may be used for detection by a MT method.

FIG. 13B shows a diagram in which the abnormal period (shaded region) is extracted from the degree of abnormality shown in FIG. 13A. The training data evaluation unit 120 stores a set of the detection period and the periods classified by the period labeling for each “selection condition generation device”.

The classification by the period labeling corresponds to a correct label in an identification problem of supervised training, and the detection period corresponds to a prediction label, but a method for calculating a performance index differs from that of normal supervised training in the following points.

First, normal discrimination learning has a binary correct label of normal and abnormal. On the other hand, the invention has four labels: the normal phase, the gray phase, the abnormal phase, and the recovery period. In addition, in a case of a normal identification problem, each time is treated as an independent instance, and a performance such as Precision and Report is calculated.

Regarding this, in the invention, a period-based Precision or Recall is used. Accordingly, there is an effect of evaluating a performance of the model in consideration of time-series factors. First, a method for calculating the period-based Recall will be described.

The abnormal period included in a set of verification data (referred to as a verification data set for simplicity) related to the “selection condition generation device” is extracted. Further, for each abnormal period, a Recall score is calculated by collating with the detection period.

The Recall score is an index showing how well one abnormal period can be detected. For example, if the abnormal period and the detection period overlap, an index of 1 may be used, and if not, an index of 0 may be used. Alternatively, a ratio of the detection period to the abnormal period may be used as an index. Alternatively, the earliest start time may be selected from the detection period included in the abnormal period, and a speed of detection for the abnormal period may be used as an index.

The Recall score is calculated for all the abnormal periods included in the verification data set, and an average value thereof is calculated as the Recall.

Next, a method for calculating the period-based Precision will be described. First, the training data evaluation unit 120 extracts the detection period included in the verification data set. Then, for each detection period, a Precision score is calculated by collating with the period label.

The Precision score is an index showing how accurately one detection period can detect an actual abnormal period. For example, if the detection period overlaps with at least one abnormal period, an index of a score value of 1 may be used, and if not, an index of a score value of 0 may be used. Alternatively, a ratio of the actual abnormal period to the detection period may be used as an index.

The Precision scores are calculated for all the abnormal periods included in the verification data set, and the average value thereof is calculated as Precision. However, here, the detection period included in the gray period or the recovery period is excluded from calculation targets of the average value. Accordingly, there is an effect of excluding the influence of the period during which it is difficult to determine the normality and abnormality or a period during which the operation of the device is unstable on the Precision.

The training data evaluation unit 120 calculates the evaluation index 121 based on the Precision and Recall that are calculated by the above method. For example, an F1 value, which is harmonic mean of the two values, may be used.

Although the best mode for carrying out the invention has been specifically described above, the invention is not limited to the embodiments, and various modifications can be made without departing from the scope of the invention.

According to the present embodiment, it is possible to assist the selection of suitable training data to be used for the sign detection even when the sign detection of the device is performed based on the large-scale measurement data or the measurement data having the complicated change pattern.

At least the following is clarified by the description of the present description. That is, the data selection assist device according to the present embodiment may include the training data selection unit configured to select a subset of a predetermined unit in a search range of the training data assumed for a second data set based on the value range predetermined for a first data set, and generate, as the training sensor data, a set by merging the first data set with the subset, and the training data evaluation unit configured to apply the training sensor data to a predetermined evaluation algorithm, and calculate an evaluation index indicating whether the model training sensor data is appropriate as the training data.

Accordingly, it is possible to select the training data more accurately. As a result, it is possible to assist the selection of suitable training data to be used for the sign detection even when the sign detection of the device is performed based on the large-scale measurement data or the measurement data having the complicated change pattern.

In addition, the data selection assist device according to the present embodiment may further include a data selection optimization unit configured to specify an optimal condition as a value range of the second data set based on the evaluation index obtained each time the subset of the predetermined unit is selected and the training sensor data is generated.

Accordingly, the value range related to the second data set can be efficiently specified. As a result, it is possible to assist the selection of suitable training data to be used for the sign detection even when the sign detection of the device is performed based on the large-scale measurement data or the measurement data having the complicated change pattern.

In addition, in the data selection assist device according to the present embodiment, for each device included in a predetermined set of target devices, the training data evaluation unit may classify, based on predetermined information obtained on a state of the device, at least the time-series sensor data corresponding to the normal period during which the device is in the normal state among the time-series sensor data obtained from the sensor, divide the time-series sensor data into training data corresponding to the normal period and verification data whose measurement time is earlier than that of the training data, train the failure prediction model regarding the device based on the training data generated by the division, apply the failure prediction model to the verification data generated by the division and calculate a degree of abnormality, and calculate the evaluation index by integrating the degrees of abnormality of all devices included in the set when calculation of the degrees of abnormality of all the devices is completed.

Accordingly, it is possible to efficiently select suitable training data for a plurality of the devices. As a result, it is possible to assist the selection of suitable training data to be used for the sign detection even when the sign detection of the device is performed based on the large-scale measurement data or the measurement data having the complicated change pattern.

In addition, the data selection assist method according to the present embodiment may include: by the information processing device, selecting the subset of a predetermined unit in a search range of the training data assumed for the second data set based on the value range predetermined for the first data set, generating, as the training sensor data, a set by merging the first data set with the subset, and applying the training sensor data to a predetermined evaluation algorithm to calculate an evaluation index indicating whether the model training sensor data is appropriate as the training data.

In addition, the data selection assist method according to the present embodiment may further include, by the information processing device, specifying an optimal condition as a value range of the second data set based on the evaluation index obtained each time the subset of the predetermined unit is selected and the training sensor data is generated.

In addition, the data selection assist method according to the present embodiment may further include: by the information processing device, for each device included in a predetermined set of target devices, classifying, based on predetermined information obtained on a state of the device, at least the time-series sensor data corresponding to a normal period during which the device is in a normal state among the time-series sensor data obtained from the sensor; dividing the time-series sensor data into training data corresponding to the normal period and verification data whose measurement time is earlier than that of the training data; training the failure prediction model regarding the device based on the training data generated by the division; applying the failure prediction model to the verification data generated by the division and calculating a degree of abnormality; and calculating the evaluation index by integrating the degrees of abnormality of all devices included in the set when calculation of the degrees of abnormality of all the devices is completed.

What is claimed is:

1. A data selection assist device comprising:
a storage unit configured to store time-series sensor data acquired from a sensor with respect to a failure prediction target device;
a data classification unit configured to classify the time-series sensor data into a first data set and a second data set while allowing the first data set and the second data set to overlap each other, based on a predetermined condition according to a type of the sensor;
a training data selection unit configured to select a subset of the second data set based on a value range of the first data set;
a training data evaluation unit configured to calculate an evaluation index indicating a suitability of a failure prediction model as training data based on the selected subset; and
a data selection condition search unit configured to search for the value range of the first data set that maximizes the evaluation index.

2. The data selection assist device according to claim 1, wherein
the training data selection unit selects the subset of a predetermined unit in a search range of the training data assumed for the second data set based on the value range predetermined for the first data set, and generates, as training sensor data, a set by merging the first data set and the subset, and
the training data evaluation unit applies the training sensor data to a predetermined evaluation algorithm to calculate an evaluation index indicating whether the training sensor data is appropriate as the training data.

3. The data selection assist device according to claim 2, further comprising:
a data selection optimization unit configured to specify an optimal condition as a value range of the second data set based on the evaluation index obtained each time the subset of the predetermined unit is selected and the training sensor data is generated.

4. The data selection assist device according to claim 2, wherein
the training data evaluation unit
for each device included in a predetermined set of target devices,
classifies, based on predetermined information obtained on a state of the device, at least the time-series sensor data corresponding to a normal period during which the device is in a normal state among the time-series sensor data obtained from the sensor,
divides the time-series sensor data into training data corresponding to the normal period and verification data whose measurement time is earlier than that of the training data,
trains the failure prediction model regarding the device based on the training data generated by the division,
applies the failure prediction model to the verification data generated by the division and calculates a degree of abnormality, and
calculates the evaluation index by integrating the degrees of abnormality of all devices included in the set when calculation of the degrees of abnormality of all the devices is completed.

5. A data selection assist method, comprising:
by an information processing device,
storing time-series sensor data acquired from a sensor with respect to a failure prediction target device;
classifying the time-series sensor data into a first data set and a second data set while allowing the first data set and the second data set to overlap each other, based on a predetermined condition according to a type of the sensor;
selecting a subset of the second data set based on a value range of the first data set;
calculating an evaluation index indicating a suitability of a failure prediction model as training data based on the selected subset; and
searching for the value range of the first data set that maximizes the evaluation index.

6. The data selection assist method according to claim 5, further comprising:
by the information processing device,
selecting the subset of a predetermined unit in a search range of the training data assumed for the second data set based on the value range predetermined for the first data set, and generating, as training sensor data, a set by merging the first data set and the subset; and
applying the training sensor data to a predetermined evaluation algorithm to calculate an evaluation index indicating whether the training sensor data is appropriate as the training data.

7. The data selection assist method according to claim 6, further comprising:
by the information processing device,
specifying an optimal condition as a value range of the second data set based on the evaluation index obtained each time the subset of the predetermined unit is selected and the training sensor data is generated.

8. The data selection assist method according to claim 6, further comprising:
by the information processing device,
for each device included in a predetermined set of target devices,
classifying, based on predetermined information obtained on a state of the device, at least the time-series sensor data corresponding to a normal period during which the device is in a normal state among the time-series sensor data obtained from the sensor;
dividing the time-series sensor data into training data corresponding to the normal period and verification data whose measurement time is earlier than that of the training data;
training the failure prediction model regarding the device based on the training data generated by the division;
applying the failure prediction model to the verification data generated by the division and calculating a degree of abnormality; and
calculating the evaluation index by integrating the degrees of abnormality of all devices included in the set when calculation of the degrees of abnormality of all the devices is completed.
